(19) United States
(12) Patent Application Publication
(10) Pub. No.: US 2018/0064215 A1
(43) Pub. Date: Mar. 8, 2018

(54) ATTACHMENT SYSTEM AND METHOD, AND ARTICLE INCORPORATING SAME

(71) Applicant: Wolf Tooth Components, LLC, Savage, MN (US)

(72) Inventor: Brendan J. Moore, Prior Lake, MN (US)

(21) Appl. No.: 15/699,339

(22) Filed: Sep. 8, 2017

Related U.S. Application Data
(60) Provisional application No. 62/385,227, filed on Sep. 8, 2016.

(51) Int. Cl. A44B 18/00; B62J 9/00

(52) U.S. Cl. CPC A44B 18/0073; A44D 2203/00; B62J 9/00

(57) ABSTRACT

An attachment system includes a first portion including a first hook-and-loop fastening element and a first magnetic coupling element, and a second portion including a second hook-and-loop fastening element and a second magnetic coupling element, with the first portion and the second portion to be magnetically coupled by the first magnetic coupling element and the second magnetic coupling element and to be mechanically fastened by the first hook-and-loop fastening element and the second hook-and-loop fastening element.

### CROSS-REFERENCE TO RELATED APPLICATIONS

This application claims priority under 35 U.S.C. §119(e) to U.S. Provisional Patent Application Ser. No. 62/385,227 filed on Sep. 8, 2016, and incorporated herein by reference.

### BACKGROUND

The present disclosure relates generally to an attachment system and method and, more specifically, relates to an attachment system and method combining hook-and-loop fastening with magnetic coupling.

### BRIEF DESCRIPTION OF THE DRAWINGS

FIG. 1A is a schematic front view of one example of a first portion of an attachment system in accordance with the present disclosure.

FIG. 1B is a schematic front view of one example of a second portion of an attachment system in accordance with the present disclosure.

FIG. 2A is an exploded perspective view of the first portion of the attachment system illustrated in FIG. 1A.

FIG. 2B is an exploded perspective view of the second portion of the attachment system illustrated in FIG. 1B.

FIG. 3A is a schematic cross-sectional view from the perspective of line 3A-3A of FIG. 1A.

FIG. 3B is a schematic cross-sectional view from the perspective of line 3B-3B of FIG. 1B.

FIGS. 4 and 5 schematically illustrate one example of an attachment method in accordance with the present disclosure, including attachment of the first portion of the attachment system illustrated in FIGS. 1A, 2A, and 3A and the second portion of the attachment system illustrated in FIGS. 1B, 2B, and 3B.

FIG. 6A is a schematic front view of another example of a first portion of an attachment system in accordance with the present disclosure.

FIG. 6B is a schematic front view of another example of a second portion of an attachment system in accordance with the present disclosure.

FIG. 7A is an exploded perspective view of the first portion of the attachment system illustrated in FIG. 6A.

FIG. 7B is an exploded perspective view of the second portion of the attachment system illustrated in FIG. 6B.

FIG. 8A is a schematic cross-sectional view from the perspective of line 8A-8A of FIG. 6A.

FIG. 8B is a schematic cross-sectional view from the perspective of line 8B-8B of FIG. 6B.

FIGS. 9 and 10 schematically illustrate another example of an attachment method in accordance with the present disclosure, including attachment of the first portion of the attachment system illustrated in FIGS. 6A, 7A, and 8A and the second portion of the attachment system illustrated in FIGS. 6B, 7B, and 8B.

FIGS. 11-23 illustrate one example of an article incorporating one example of an attachment system and method in accordance with the present disclosure, including a perspective view, a side view, a top view, a cross-sectional view, and a detail view of the article in an open configuration in respective FIGS. 11, 12, 13, 14, and 14a, a perspective view, a side view, a top view, a cross-sectional view, and a detail view of the article in a partially closed configuration in respective FIGS. 15, 16, 17, 18, and 18a, and a perspective view, a side view, a top view, a cross-sectional view, and a detail view of the article in a closed configuration in respective FIGS. 19, 20, 21, 22, and 22a.

FIGS. 24-26 illustrate one example of an environment for the article of FIGS. 11-23.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims.

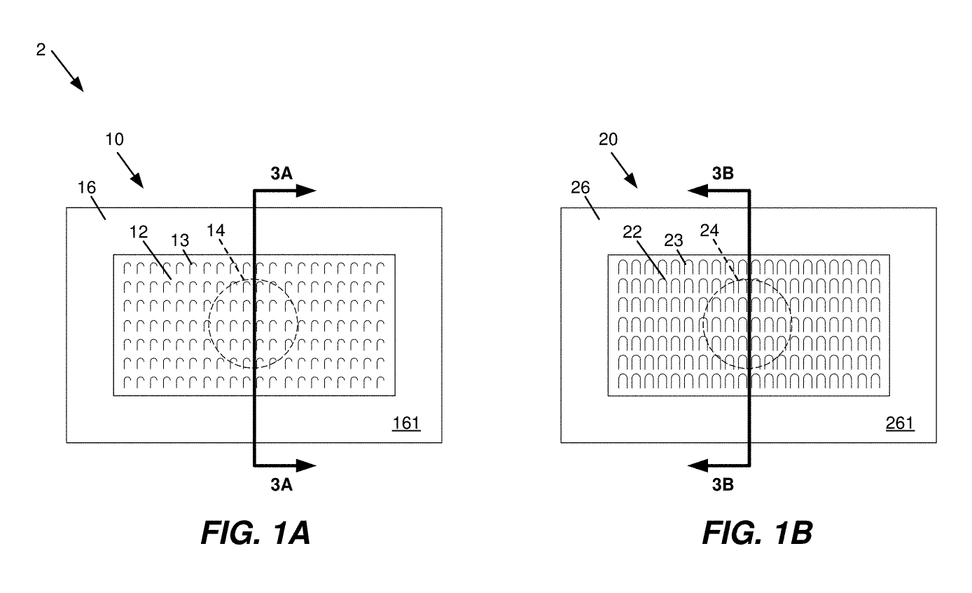

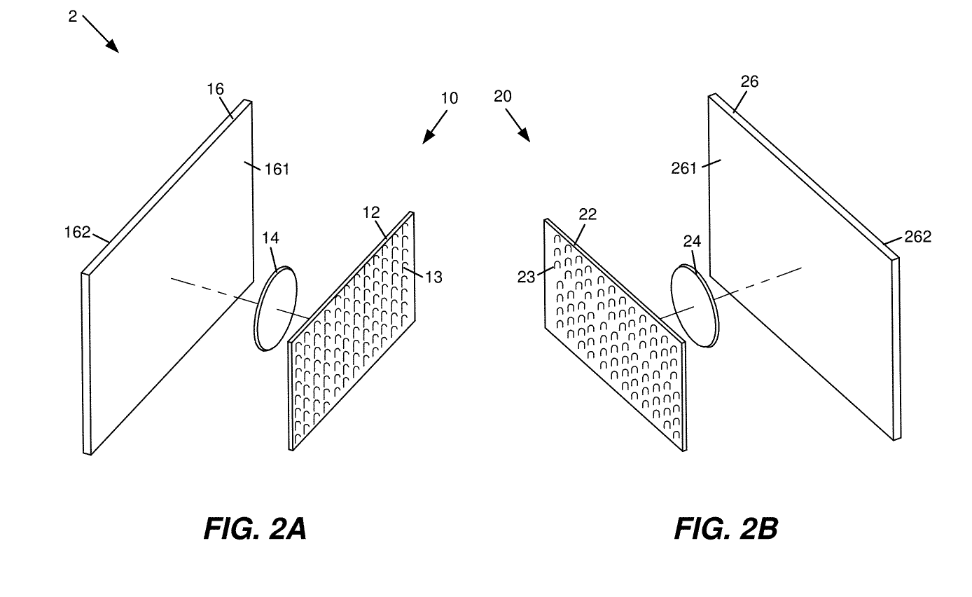

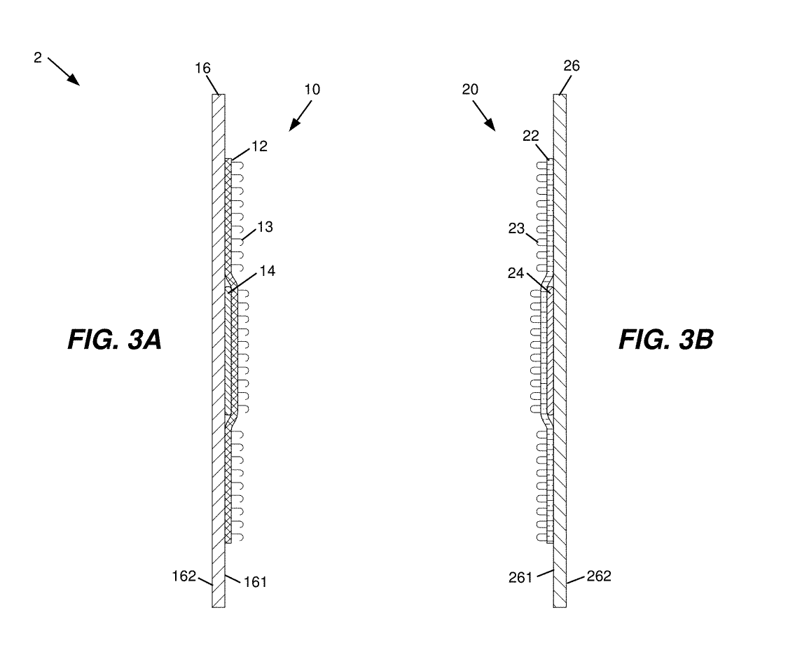

FIGS. 1A and 1B, FIGS. 2A and 2B, and FIGS. 3A and 3B schematically illustrate one example of an attachment system 2 in accordance with the present disclosure. In one example, attachment system 2 includes a first portion 10 and a second portion 20.

As illustrated in the example of FIGS. 1A, 2A, and 3A, first portion 10 of attachment system 2 includes a hook-and-loop fastening element 12 and a magnetic coupling element 14. In addition, in one implementation, first portion 10 includes or is attached to, secured to, positioned on, or supported by a backing layer or backing material 16. In one example, backing material 16 has a first major surface 161 and a second major surface 162 opposite first major surface 161. In one implementation, backing material 16 including, more specifically, first major surface 161 of backing material 16 forms a supporting layer or supporting surface for hook-and-loop fastening element 12 and magnetic coupling element 14. Backing material 16 may be formed of, include one or more layers of, or include a combination of fabric, leather, paper, paperboard, wood, metal, plastic, rubber, or the like, and may be flexible or rigid, including semi-flexible or semi-rigid. Backing material 16 may be, or may be part of, an article, object, component, or other element.

In one example, hook-and-loop fastening element 12 is attached to, secured to, or positioned on backing material 16 including, more specifically, first major surface 161 of backing material 16. For example, hook-and-loop fastening element 12 may be sewn on, adhesively bonded to, ultrasonically welded to, or laser welded to backing material 16. In one implementation, hook-and-loop fastening element 12 is or includes a hook portion 13 with hook-like members formed on or extending from a surface thereof.

In one example, magnetic coupling element 14 is attached to, secured to, positioned on, held against, or in contact with hook-and-loop fastening element 12 including, more specifically, a surface of hook-and-loop fastening element 12 opposite hook portion 13. For example, magnetic coupling element 14 may be bonded to, fastened to, or coupled with hook-and-loop fastening element 12. Alternately, or additionally, in another example, magnetic coupling element 14 is attached to, secured to, positioned on, held against, or in contact with backing material 16 including, more specifically, first major surface 161 of backing material 16. For example, magnetic coupling element 14 may be bonded to, fastened to, or coupled with backing material 16. Magnetic coupling element 14 is or includes a magnet or is or includes an element (i.e., keeper) formed of a material to which a magnet may be attracted (e.g., a ferrous material). Magnetic coupling element 14 may be a disk, plate, strip, or sheet, and may be of circular, rectangular, or other shape.

Similar to first portion 10 of attachment system 2, and as illustrated in the example of FIGS. 1B, 2B, and 3B, second portion 20 of attachment system 2 includes a hook-and-loop fastening element 22 and a magnetic coupling element 24. In addition, in one implementation, second portion 20 includes or is attached to, secured to, positioned on, or supported by a backing layer or backing material 26. In one example, backing material 26 has a first major surface 261 and a second major surface 262 opposite first major surface 261. In one implementation, backing material 26 including, more specifically, first major surface 261 of backing material 26 forms a supporting layer or supporting surface for hook-and-loop fastening element 22 and magnetic coupling element 24. Backing material 26 may be formed of, include one or more layers of, or include a combination of fabric, leather, paper, paperboard, wood, metal, plastic, rubber, or the like, and may be flexible or rigid, including semi-flexible or semi-rigid. Backing material 26 may be, or may be part of, an article, object, component, or other element.

In one example, hook-and-loop fastening element 22 is attached to, secured to, or positioned on backing material 26 including, more specifically, first major surface 261 of backing material 26. For example, hook-and-loop fastening element 22 may be sewn on, adhesively bonded to, ultrasonically welded to, or laser welded to backing material 26. In one implementation, hook-and-loop fastening element 22 is or includes a loop portion 23 with loop-like members formed on or extending from a surface thereof.

In one example, magnetic coupling element 24 is attached to, secured to, positioned on, held against, or in contact with hook-and-loop fastening element 22 including, more specifically, a surface of hook-and-loop fastening element 22 opposite loop portion 23. For example, magnetic coupling element 24 may be bonded to, fastened to, or coupled with hook-and-loop fastening element 22. Alternately, or additionally, in another example, magnetic coupling element 24 is attached to, secured to, positioned on, held against, or in contact with backing material 26 including, more specifically, first major surface 261 of backing material 26. For example, magnetic coupling element 24 may be bonded to, fastened to, or coupled with backing material 26. Magnetic coupling element 24 is or includes a magnet or, if magnetic coupling element 14 is or includes a magnet, is or includes an element (i.e., keeper) formed of a material to which a magnet may be attracted (e.g., a ferrous material). Magnetic coupling element 24 may be a disk, plate, strip, or sheet, and may be of circular, rectangular, or other shape.

As illustrated in the example of FIGS. 1A, 2A, and 3A, magnetic coupling element 14 is positioned between hook-and-loop fastening element 12 and backing material 16 such that hook-and-loop fastening element 12 extends over or covers magnetic coupling element 14. In addition, as illustrated in the example of FIGS. 1B, 2B, and 3B, magnetic coupling element 24 is positioned between hook-and-loop fastening element 22 and backing material 26 such that hook-and-loop fastening element 22 extends over or covers magnetic coupling element 24. In one example, hook-and-loop fastening element 12 and hook-and-loop fastening element 22 are each flexible so as to conform to (at least partially) respective magnetic coupling element 14 and magnetic coupling element 24. As such, hook-and-loop fastening element 12 and hook-and-loop fastening element 22 each include or form an indented area or “pocket” to accommodate a thickness (or at least a partial thickness) of respective magnetic coupling element 14 and magnetic coupling element 24.

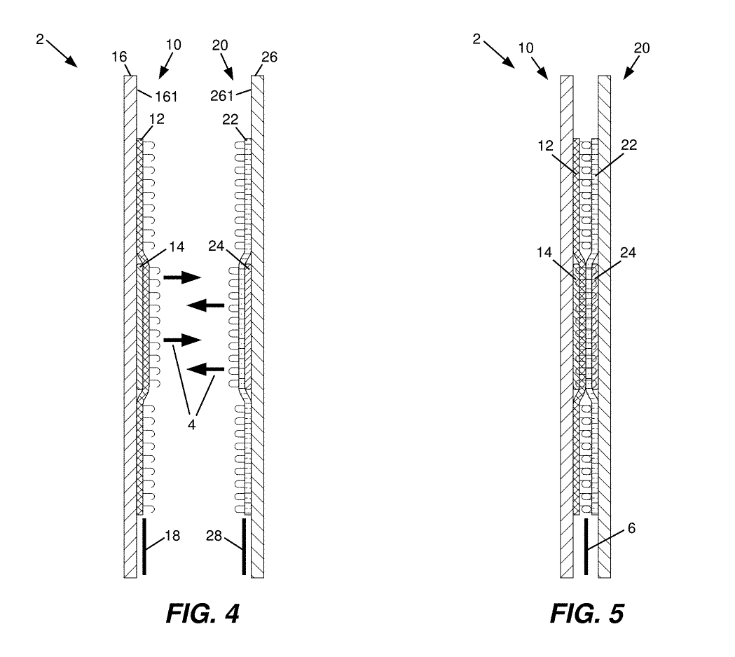

FIGS. 4 and 5 schematically illustrate one example of an attachment method in accordance with the present disclosure, including attachment of first portion 10 of attachment system 2, as illustrated in the example of FIGS. 1A, 2A, and 3A, and second portion 20 of attachment system 2, as illustrated in the example of FIGS. 1B, 2B, and 3B.

As illustrated in the example of FIG. 4, in or for attachment of first portion 10 and second portion 20, first portion 10 and second portion 20 are opposed to each other (substantially or generally) such that first major surface 161 of backing material 16 of first portion 10 and first major surface 261 of backing material 26 of second portion 20 face each other (substantially or generally). In addition, hook-and-loop fastening element 12 of first portion 10 and hook-and-loop fastening element 22 of second portion 20 face each other (substantially or generally). As such, an engagement, attachment, interaction, interface, coupling, or connection plane 18 of first portion 10, as extended along hook-and-loop fastening element 12 and magnetic coupling element 14 and/or as extended (substantially) parallel with a surface of hook-and-loop fastening element 12 and magnetic coupling element 14, and an engagement, attachment, interaction, interface, coupling, or connection plane 28 of second portion 20, as extended along hook-and-loop fastening element 22 and magnetic coupling element 24 and/or as extended (substantially) parallel with a surface of hook-and-loop fastening element 22 and magnetic coupling element 24, oppose or face each other.

As illustrated in the example of FIG. 4, with first portion 10 and second portion 20 opposed to each other (substantially or generally), as first portion 10 and second portion 20 are brought into proximity of each other, magnetic coupling element 14 and magnetic coupling element 24 attract or interact to magnetically “pull” first portion 10 and second portion 20 together, for example, as represented by arrows 4. As such, magnetic coupling element 14 and magnetic coupling element 24 magnetically couple first portion 10 and second portion 20.

As magnetic coupling element 14 and magnetic coupling element 24 “pull” first portion 10 and second portion 20 together, magnetic coupling element 14 and magnetic coupling element 24 also function to align first portion 10 and second portion 20. More specifically, as magnetic coupling element 14 and magnetic coupling element 24 are magnetically coupled, hook-and-loop fastening element 12 of first portion 10 and hook-and-loop fastening element 22 of second portion 20 are aligned with each other (substantially or generally). Thus, as first portion 10 and second portion 20 are magnetically coupled, hook-and-loop fastening element 12 and hook-and-loop fastening element 22 mechanically fasten first portion 10 and second portion 20.

As illustrated in the example of FIG. 5, first portion 10 and second portion 20 of attachment system 2 are magnetically coupled by magnetic coupling element 14 and magnetic coupling element 24, and are mechanically fastened by hook-and-loop fastening element 12 and hook-and-loop fastening element 22. As such, with attachment system 2, as illustrated and described herein, first portion 10 and second portion 20 are magnetically coupled and mechanically fastened along a single or common attachment, coupling, or connection plane 6.

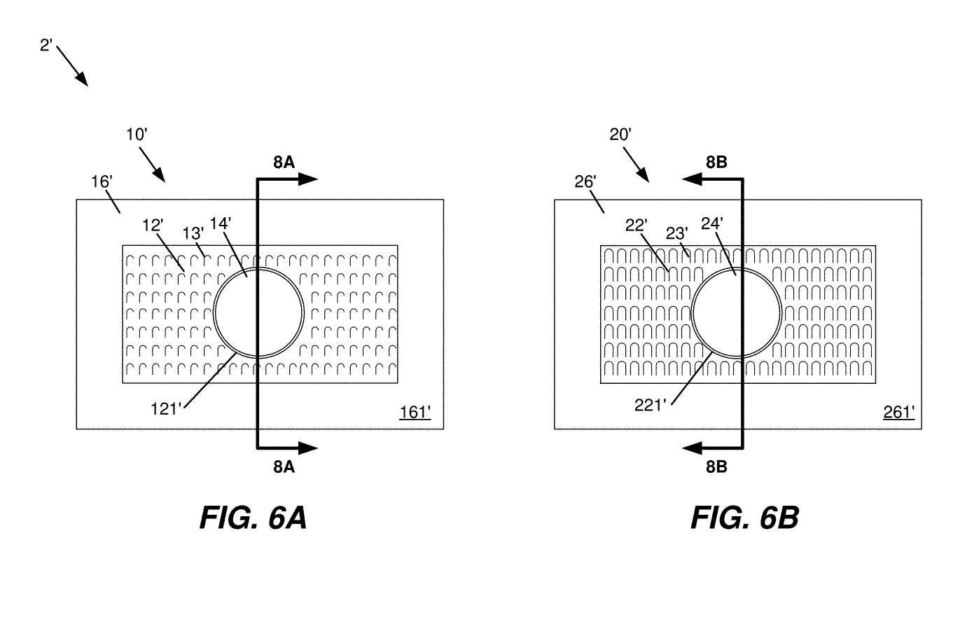

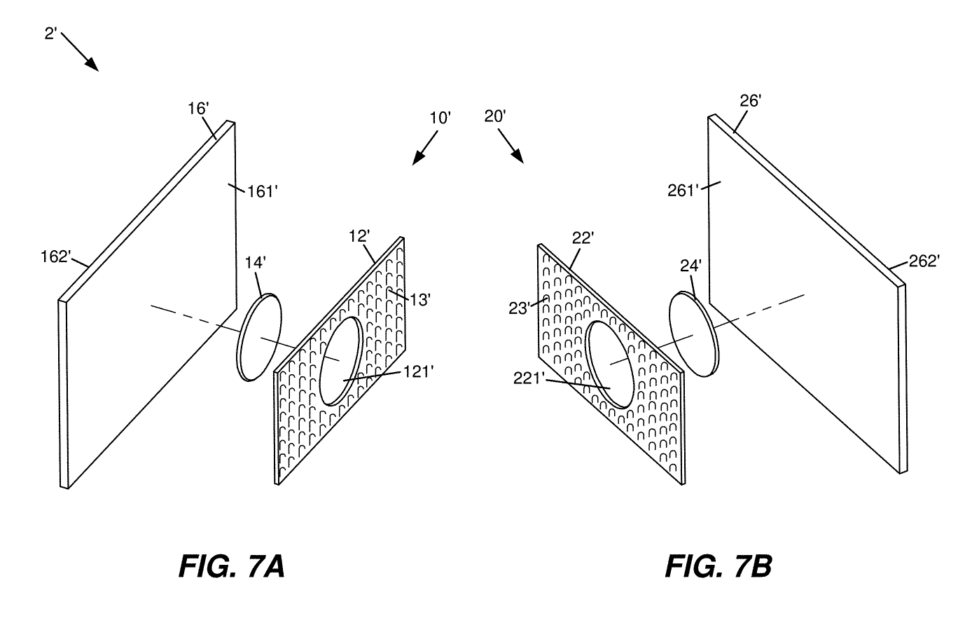

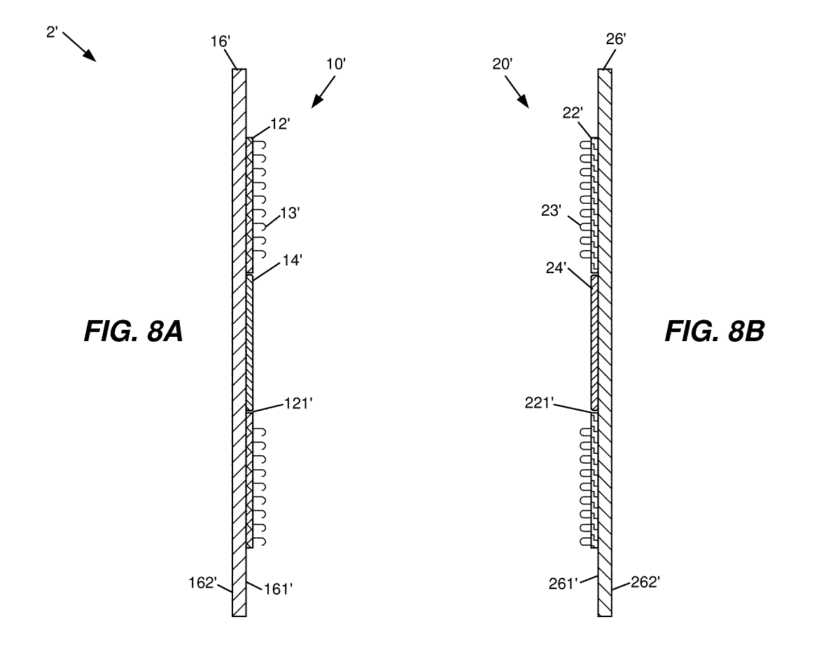

FIGS. 6A and 6B, FIGS. 7A and 7B, and FIGS. 8A and 8B schematically illustrate another example of an attachment system 2′ in accordance with the present disclosure. In one example, attachment system 2′ includes a first portion 10′ and a second portion 20′.

As illustrated in the example of FIGS. 6A, 7A, and 8A, first portion 10′ of attachment system 2′ includes a hook-and-loop fastening element 12′ and a magnetic coupling element 14′. In addition, in one implementation, first portion 10′ includes or is attached to, secured to, positioned on, or supported by a backing layer or backing material 16′. In one example, backing material 16′ is similar to backing material 16 of attachment system 2, and has a first major surface 161′ and a second major surface 162′ opposite first major surface 161′. As such, in one implementation, backing material 16′ including, more specifically, first major surface 161′ of backing material 16′ forms a supporting layer or supporting surface for hook-and-loop fastening element 12′ and magnetic coupling element 14′. Backing material 16′ may be formed of, include one or more layers of, or include a combination of fabric, leather, paper, paperboard, wood, metal, plastic, rubber, or the like, and may be flexible or rigid, including semi-flexible or semi-rigid. Backing material 16′ may be, or may be part of, an article, object, component, or other element.

In one example, hook-and-loop fastening element 12′ is attached to, secured to, or positioned on backing material 16′ including, more specifically, first major surface 161′ of backing material 16′. For example, hook-and-loop fastening element 12′ may be sewn on, adhesively bonded to, ultrasonically welded to, or laser welded to backing material 16′. In one implementation, hook-and-loop fastening element 12′ is or includes a hook portion 13′ with hook-like members formed on or extending from a surface thereof. In one example, hook-and-loop fastening element 12′ includes an opening or hole 121′ to receive magnetic coupling element 14′, as described below.

In one example, magnetic coupling element 14′ is attached to, secured to, positioned on, held against, or in contact with backing material 16′ including, more specifically, first major surface 161′ of backing material 16′. For example, magnetic coupling element 14′ may be bonded to, fastened to, or coupled with backing material 16′. Magnetic coupling element 14′ is or includes a magnet or is or includes an element (i.e., keeper) formed of a material to which a magnet may be attracted (e.g., a ferrous material). Magnetic coupling element 14′ may be a disk, plate, strip, or sheet, and may be of circular, rectangular, or other shape.

Similar to first portion 10′ of attachment system 2′, and as illustrated in the example of FIGS. 6B, 7B, and 8B, second portion 20′ of attachment system 2′ includes a hook-and-loop fastening element 22′ and a magnetic coupling element 24′. In addition, in one implementation, second portion 20′ includes or is attached to, secured to, positioned on, or supported by a backing layer or backing material 26′. In one example, backing material 26′ is similar to backing material 26 of attachment system 2, and has a first major surface 261′ and a second major surface 262′ opposite first major surface 261′. As such, in one implementation, backing material 26′ including, more specifically, first major surface 261′ of backing material 26′ forms a supporting layer or supporting surface for hook-and-loop fastening element 22′ and magnetic coupling element 24′. Backing material 26′ may be formed of, include one or more layers of, or include a combination of fabric, leather, paper, paperboard, wood, metal, plastic, rubber, or the like, and may be flexible or rigid, including semi-flexible or semi-rigid. Backing material 26′ may be, or may be part of, an article, object, component, or other element.

In one example, hook-and-loop fastening element 22′ is attached to, secured to, or positioned on backing material 26′ including, more specifically, first major surface 261′ of backing material 26′. For example, hook-and-loop fastening element 22′ may be sewn on, adhesively bonded to, ultrasonically welded to, or laser welded to backing material 26′. In one implementation, hook-and-loop fastening element 22′ is or includes a loop portion 23′ with loop-like members formed on or extending from a surface thereof. In one example, hook-and-loop fastening element 22′ includes an opening or hole 221′ to receive magnetic coupling element 24′, as described below.

In one example, magnetic coupling element 24′ is attached to, secured to, positioned on, held against, or in contact with backing material 26′ including, more specifically, first major surface 261′ of backing material 26′. For example, magnetic coupling element 24′ may be bonded to, fastened to, or coupled with backing material 26′. Magnetic coupling element 24′ is or includes a magnet or, if magnetic coupling element 14′ is or includes a magnet, is or includes an element (i.e., keeper) formed of a material to which a magnet may be attracted (e.g., a ferrous material). Magnetic coupling element 24′ may be a disk, plate, strip, or sheet, and may be of circular, rectangular, or other shape.

As illustrated in the example of FIGS. 6A, 7A, and 8A, magnetic coupling element 14′ is received in or positioned within hole 121′ of hook-and-loop fastening element 12′ such that, in a plane (substantially) parallel with first major surface 161′ of backing material 16′, hook-and-loop fastening element 12′ surrounds magnetic coupling element 14′. In addition, as illustrated in the example of FIGS. 6B, 7B, and 8B, magnetic coupling element 24′ is received in or positioned within hole 221′ of hook-and-loop fastening element 22′ such that, in a plane (substantially) parallel with first major surface 261′ of backing material 26′, hook-and-loop fastening element 22′ surrounds magnetic coupling element 24′. As such, magnetic coupling element 14′ is or remains exposed on first portion 10′, and magnetic coupling element 24′ is or remains exposed on first portion 20′.

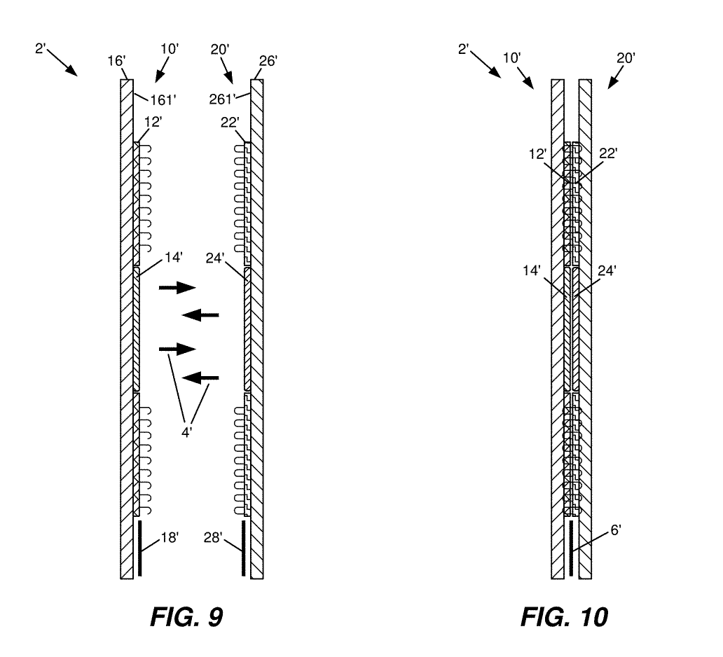

FIGS. 9 and 10 schematically illustrate one example of an attachment method in accordance with the present disclosure, including attachment of first portion 10′ of attachment system 2′, as illustrated in the example of FIGS. 6A, 7A, and 8A, and second portion 20′ of attachment system 2′, as illustrated in the example of FIGS. 6B, 7B, and 8B.

As illustrated in the example of FIG. 9, in or for attachment of first portion 10′ and second portion 20′, first portion 10′ and second portion 20′ are opposed to each other (substantially or generally) such that first major surface 161′ of backing material 16′ of first portion 10′ and first major surface 261′ of backing material 26′ of second portion 20′ face each other (substantially or generally). In addition, hook-and-loop fastening element 12′ of first portion 10′ and hook-and-loop fastening element 22′ of second portion 20′ face each other (substantially or generally). As such, an engagement, attachment, interaction, interface, coupling, or connection plane 18′ of first portion 10′, as extended along hook-and-loop fastening element 12′ and magnetic coupling element 14′ and/or as extended (substantially) parallel with a surface of hook-and-loop fastening element 12′ and magnetic coupling element 14′, and an engagement, attachment, interaction, interface, coupling, or connection plane 28′ of second portion 20′, as extended along hook-and-loop fastening element 22′ and magnetic coupling element 24′ and/or as extended (substantially) parallel with a surface of hook-and-loop fastening element 22′ and magnetic coupling element 24′, oppose or face each other.

As illustrated in the example of FIG. 9, with first portion 10′ and second portion 20′ opposed to each other (substantially or generally), as first portion 10′ and second portion 20′ are brought into proximity of each other, magnetic coupling element 14′ and magnetic coupling element 24′ attract or interact to magnetically “pull” first portion 10′ and second portion 20′ together, for example, as represented by arrows 4′. As such, magnetic coupling element 14′ and magnetic coupling element 24′ magnetically couple first portion 10′ and second portion 20′.

As magnetic coupling element 14′ and magnetic coupling element 24′ “pull” first portion 10′ and second portion 20′ together, magnetic coupling element 14′ and magnetic coupling element 24′ also function to align first portion 10′ and second portion 20′. More specifically, as magnetic coupling element 14′ and magnetic coupling element 24′ are magnetically coupled, hook-and-loop fastening element 12′ of first portion 10′ and hook-and-loop fastening element 22′ of second portion 20′ are aligned with each other (substantially or generally). Thus, as first portion 10′ and second portion 20′ are magnetically coupled, hook-and-loop fastening element 12′ and hook-and-loop fastening element 22′ mechanically fasten first portion 10′ and second portion 20′.

As illustrated in the example of FIG. 10, first portion 10′ and second portion 20′ of attachment system 2′ are magnetically coupled by magnetic coupling element 14′ and magnetic coupling element 24′, and are mechanically fastened by hook-and-loop fastening element 12′ and hook-and-loop fastening element 22′. As such, with attachment system 2′, as illustrated and described herein, first portion 10′ and second portion 20′ are magnetically coupled and mechanically fastened along a single or common attachment, coupling, or connection plane 6′.

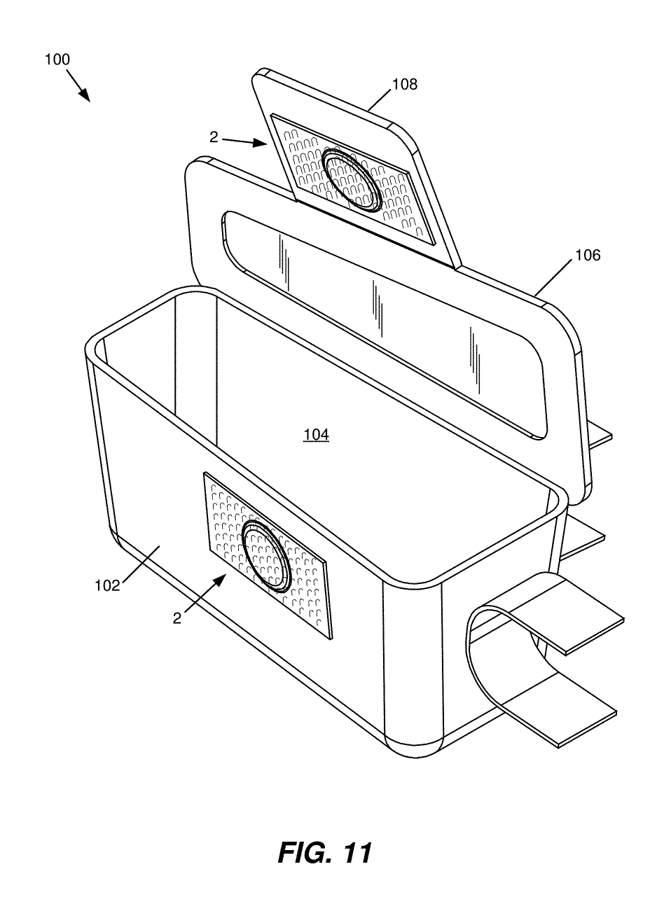

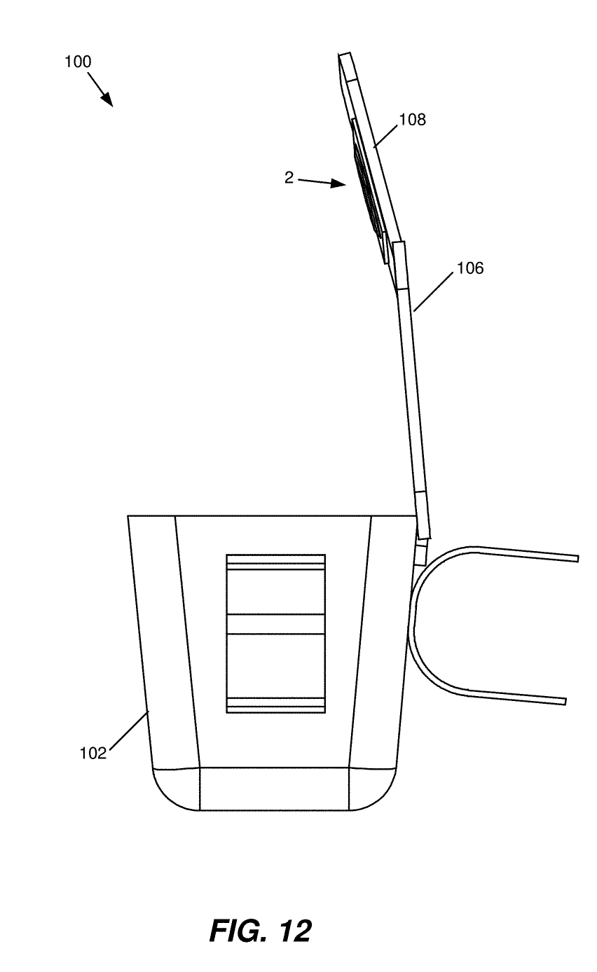

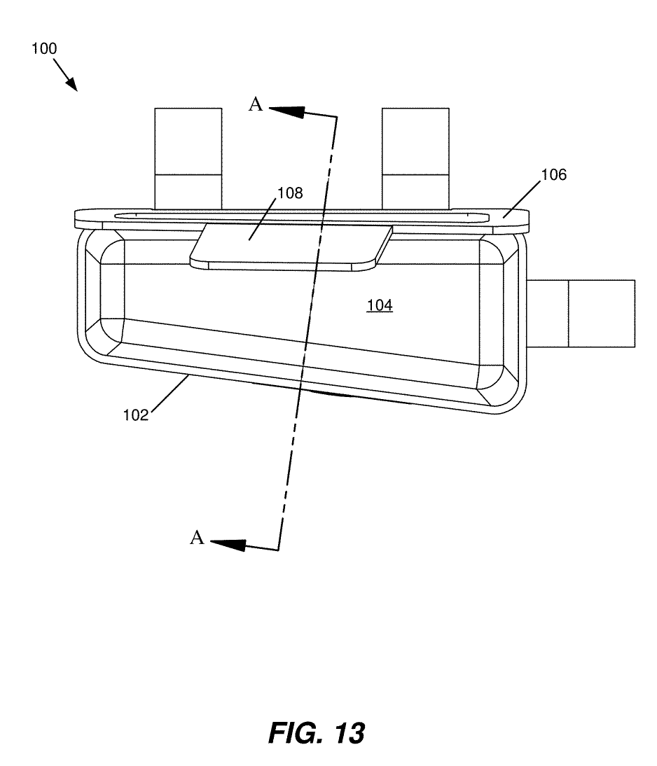

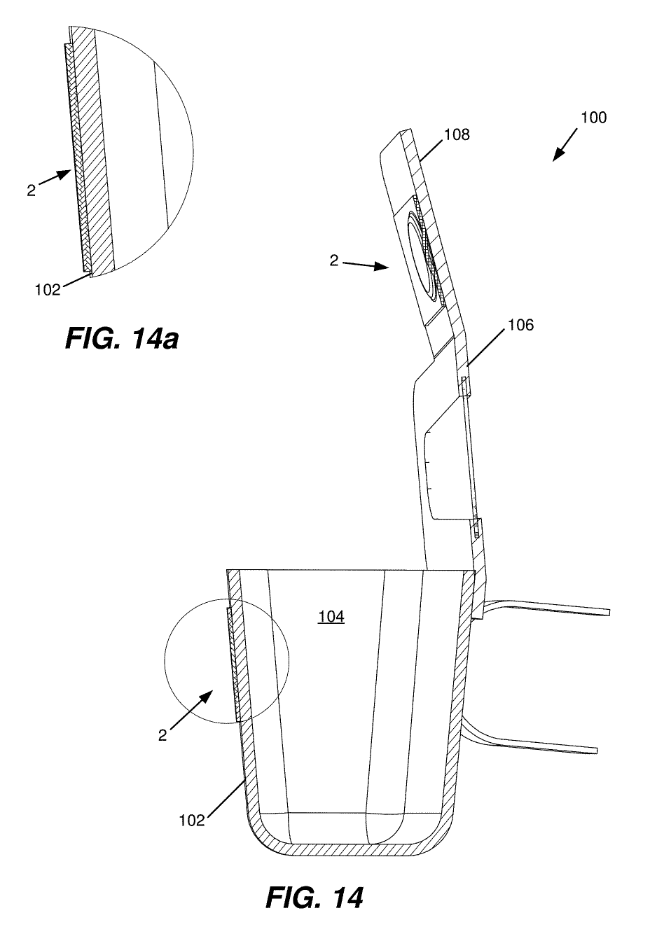

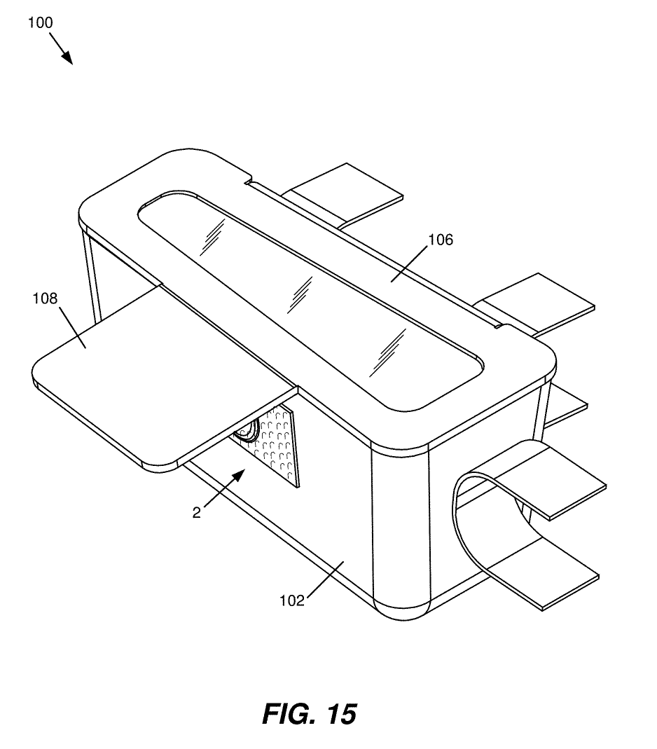

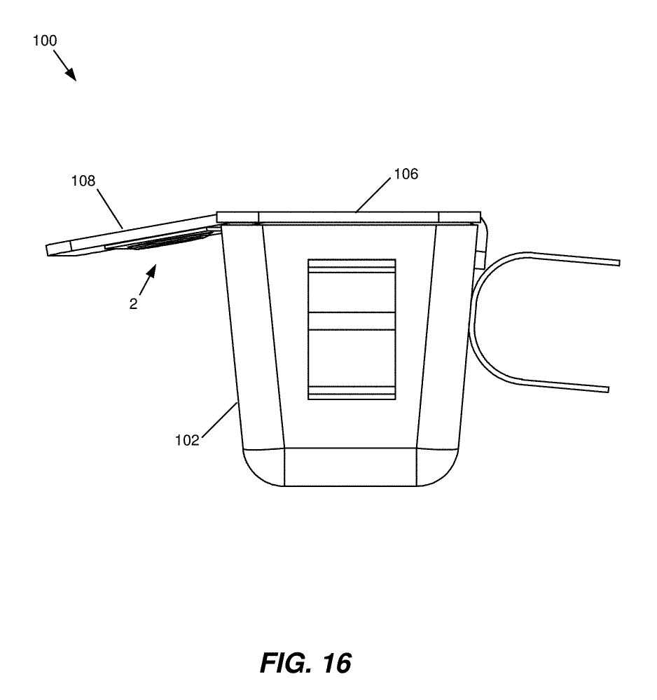

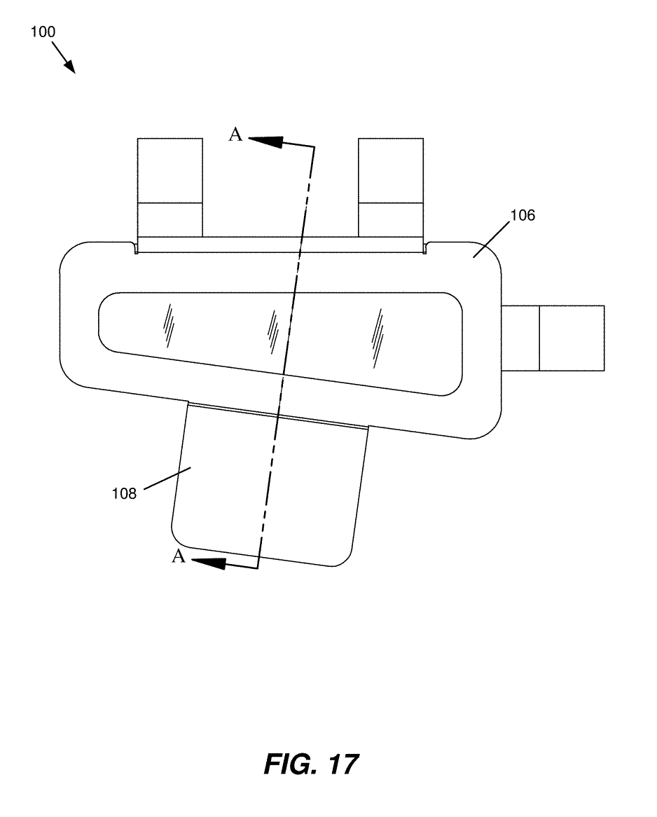

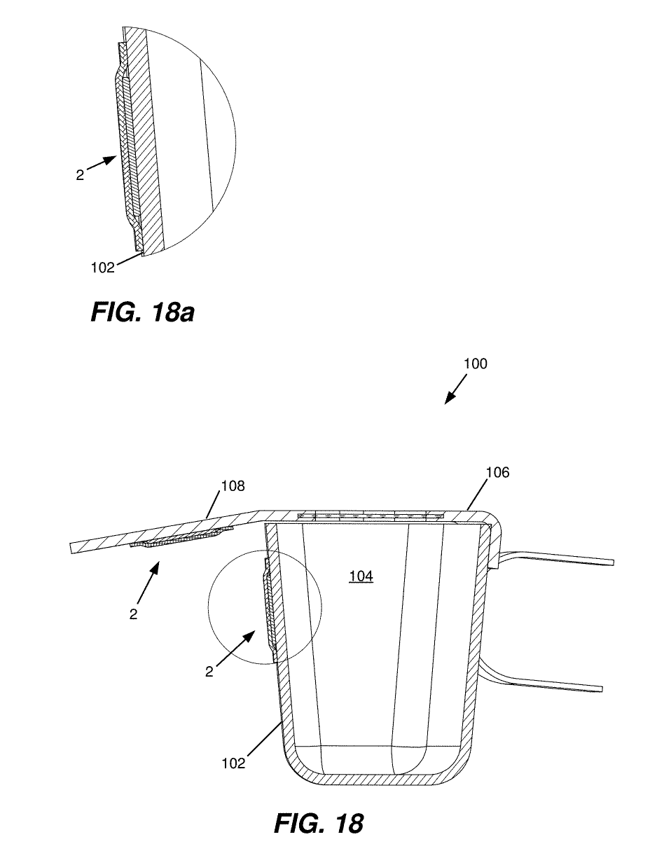

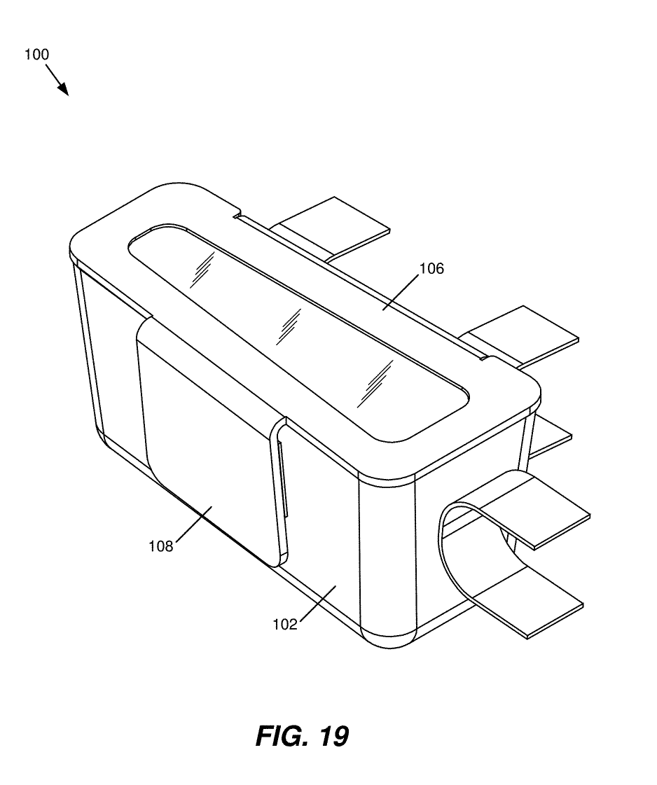

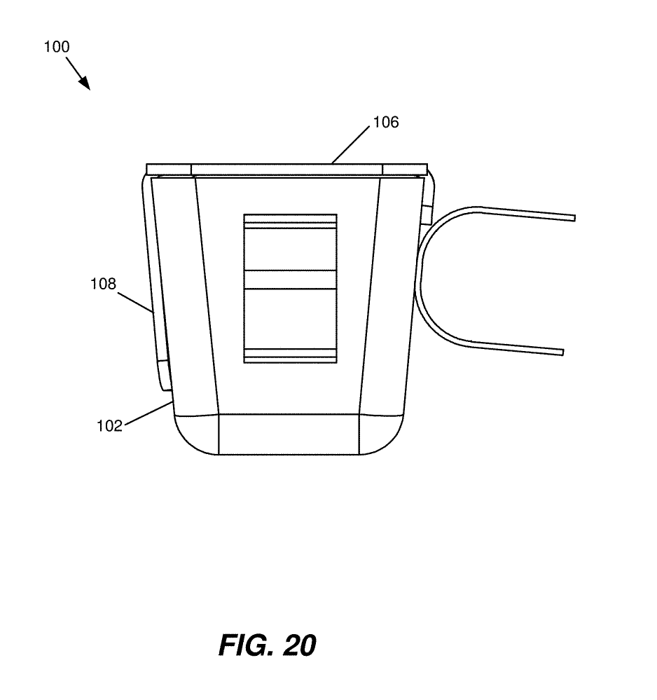

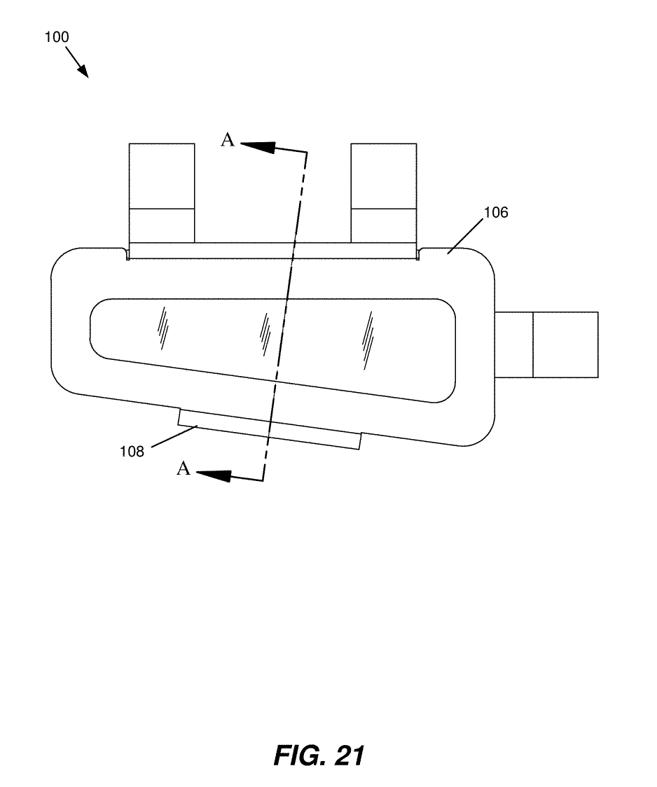

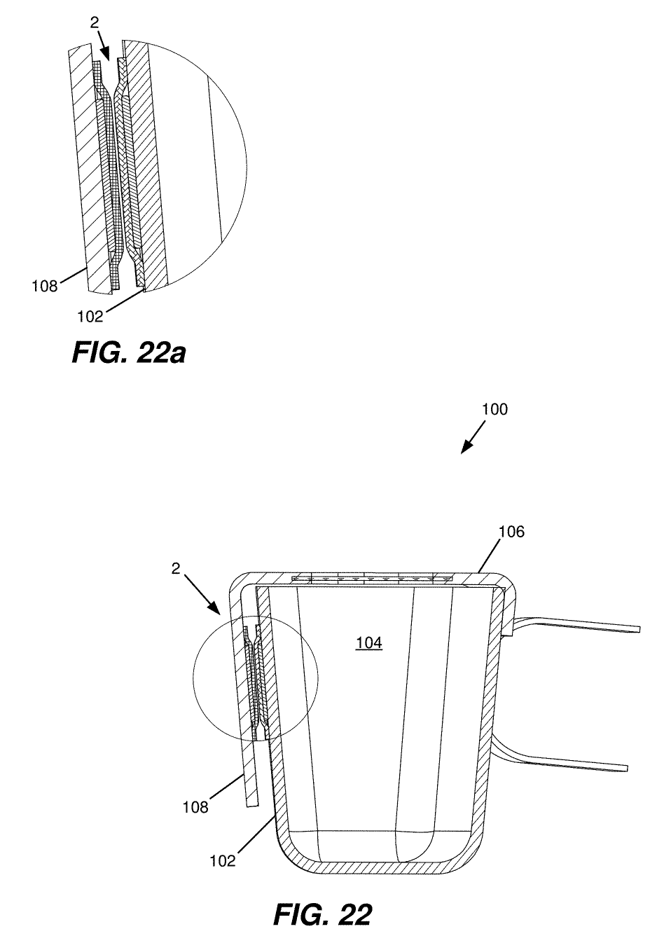

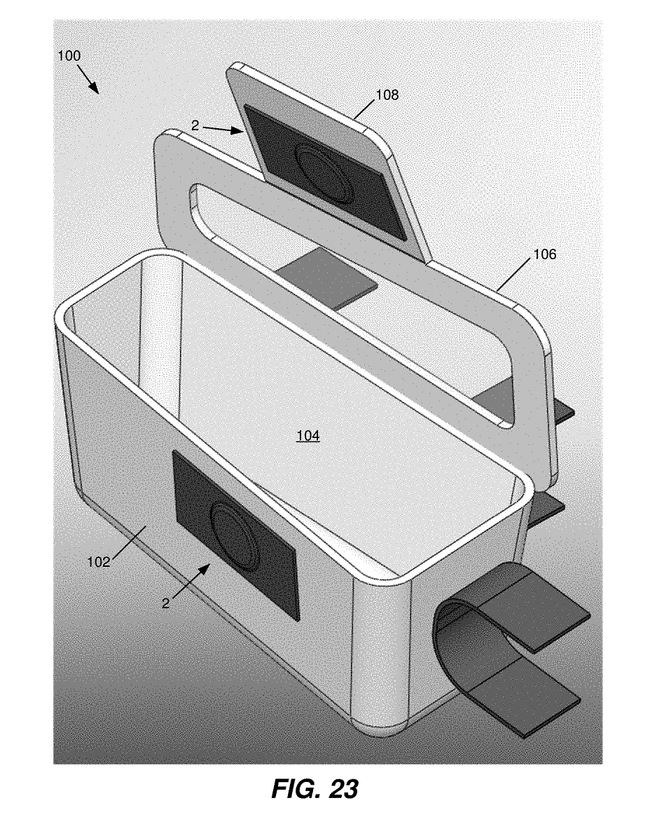

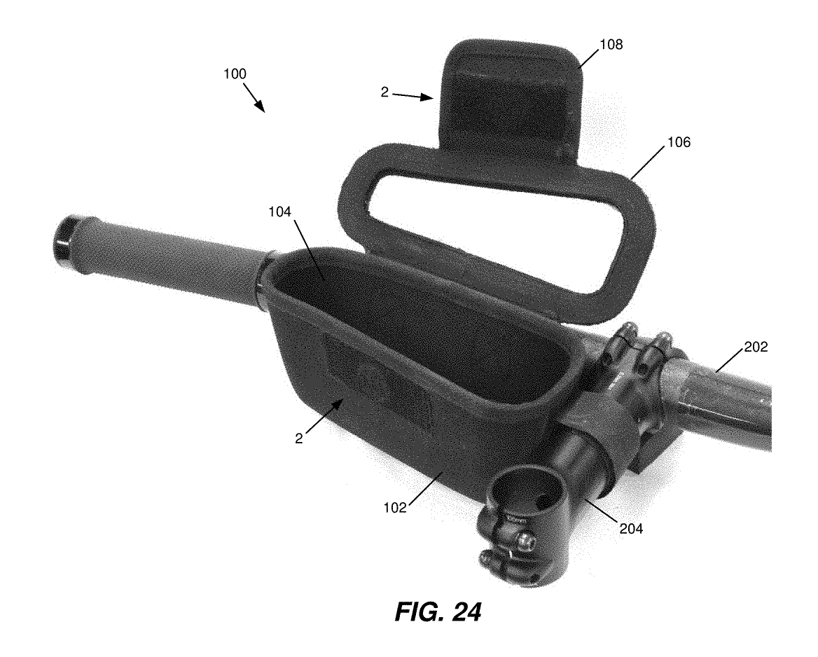

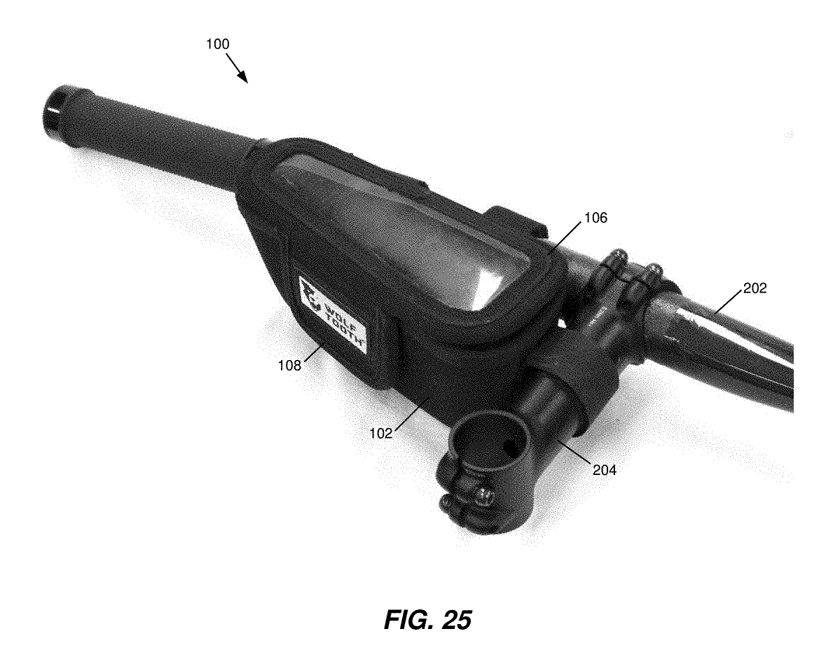

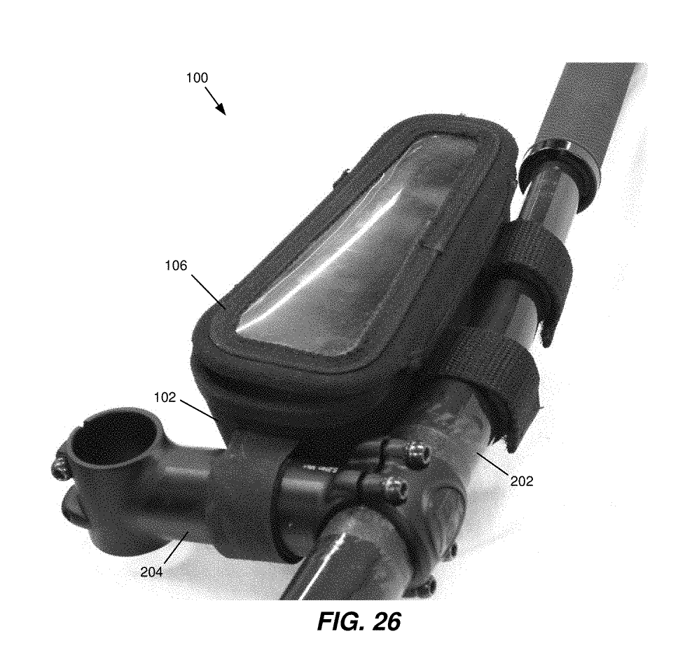

FIGS. 11-23 illustrate one example of an article incorporating one example of an attachment system and method in accordance with the present disclosure, including a perspective view, a side view, a top view, a cross-sectional view, and a detail view of the article in an open configuration in respective FIGS. 11, 12, 13, 14, and 14a, a perspective view, a side view, a top view, a cross-sectional view, and a detail view of the article in a partially closed configuration in respective FIGS. 15, 16, 17, 18, and 18a, and a perspective view, a side view, a top view, a cross-sectional view, and a detail view of the article in a closed configuration in respective FIGS. 19, 20, 21, 22, and 22a, with FIG. 14 including a cross-sectional view from the perspective of line A-A of FIG. 13 and FIG. 14a including a detail view of the area within the circle of FIG. 14, with FIG. 18 including a cross-sectional view from the perspective of line A-A of FIG. 17 and FIG. 18a including a detail view of the area within the circle of FIG. 18, and with FIG. 22 including a cross-sectional view from the perspective of line A-A of FIG. 21 and FIG. 22a including a detail view of the area within the circle of FIG. 22, and FIGS. 24-26 illustrate one example of an environment for the article of FIGS. 11-23.

For example, FIGS. 11-23 illustrate one example of an accessory bag 100 including a base portion 102 forming a cavity or receptacle 104 and a lid portion 106 having a flap 108 extending therefrom. In one example, the lid portion 106 is hingedly coupled with the base portion 102, and is openable and closable relative to the base portion 102. In one implementation, the base portion 102 and the lid portion 106, including, more specifically, the flap 108 of the lid portion 106, include respective portions of attachment system 2 (or attachment system 2′) as illustrated and described herein. In one example, as illustrated in FIGS. 24-26, the accessory bag 100 (with attachment system 2 (or attachment system 2′)) is a bicycle accessory bag. As such, in one implementation, the accessory bag 100 is attached to a handlebar 202 and/or a handlebar stem 204 of a bicycle. Although illustrated for use with an accessory bag, attachment system 2 (or attachment system 2′), as illustrated and described herein, may be incorporated in, added to, used with, or included as part of other articles, objects, components, or elements.

Although specific examples have been illustrated and described herein, it will be appreciated by those of ordinary skill in the art that a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

What is claimed is:

1. An attachment system, comprising:
a first portion including a first hook-and-loop fastening element and a first magnetic coupling element; and
a second portion including a second hook-and-loop fastening element and a second magnetic coupling element,
the first portion and the second portion to be magnetically coupled by the first magnetic coupling element and the second magnetic coupling element and to be mechanically fastened by the first hook-and-loop fastening element and the second hook-and-loop fastening element.

2. The system of claim 1, the first portion and the second portion to be both magnetically coupled by the first magnetic coupling element and the second magnetic coupling element and mechanically fastened by the first hook-and-loop fastening element and the second hook-and-loop fastening element along a common plane.

3. The system of claim 1, the first hook-and-loop fastening element including one of a hook portion and a loop portion, and the second hook-and-loop fastening element including the other of the hook portion and the loop portion.

4. The system of claim 3, the first magnetic coupling element to contact the first hook-and-loop fastening element opposite the one of the hook portion and the loop portion of the first hook-and-loop fastening element, and the second magnetic coupling element to contact the second hook-and-loop fastening element opposite the other of the hook portion and the loop portion of the second hook-and-loop fastening element.

5. The system of claim 1, the first portion to be supported by a backing material.

6. The system of claim 1, the second portion to be supported by a backing material.

7. The system of claim 5, the backing material having a first major surface, and both the first magnetic coupling element and the first hook-and-loop fastening element to contact the first major surface of the backing material.

8. The system of claim 6, the backing material having a first major surface, and both the second magnetic coupling element and the second hook-and-loop fastening element to contact the first major surface of the backing material.

9. The system of claim 5, the first magnetic coupling element to be positioned between the backing material and the first hook-and-loop fastening element.

10. The system of claim 6, the second magnetic coupling element to be positioned between the backing material and the second hook-and-loop fastening element.

11. The system of claim 1, the first magnetic coupling element to be positioned within a hole of the first hook-and-loop fastening element.

12. The system of claim 1, the second magnetic coupling element to be positioned within a hole of the second hook-and-loop fastening element.

13. An article including the attachment system of claim 1.

14. The article of claim 13, the article comprising a bicycle accessory bag.

15. An attachment method, comprising:
magnetically coupling a first portion and a second portion with a first magnetic coupling element of the first portion and a second magnetic coupling element of the second portion; and
mechanically fastening the first portion and the second portion with a first hook-and-loop fastening element of the first portion and a second hook-and-loop fastening element of the second portion.

16. The method of claim 15, magnetically coupling the first portion and the second portion and mechanically fastening the first portion and the second portion including both magnetically coupling the first portion and the second portion with the first magnetic coupling element and the second magnetic coupling element and mechanically fastening the first portion and the second portion with the first hook-and-loop fastening element and the second hook-and-loop fastening element along a common plane.

17. The method of claim 15, the first hook-and-loop fastening element including one of a hook portion and a loop portion, and the second hook-and-loop fastening element including the other of the hook portion and the loop portion.

18. The method of claim 17, contacting the first hook-and-loop fastening element opposite the one of the hook portion and the loop portion with the first magnetic coupling element, and contacting the second hook-and-loop fastening element opposite the other of the hook portion and the loop portion with the second magnetic coupling element.

19. The method of claim 15, covering the first magnetic coupling element with the first hook-and-loop fastening element, and covering the second magnetic coupling element with the second hook-and-loop fastening element.

20. The method of claim 15, exposing the first magnetic coupling element through the first hook-and-loop fastening element, and exposing the second magnetic coupling element through the second hook-and-loop fastening element.
